(19) United States
(12) Patent Application Publication
(10) Pub. No.: US 2010/0320031 A1
(43) Pub. Date: Dec. 23, 2010

(54) Adjustable Base Tree Stand

(76) Inventors: Michael H. WEBER, Seymour, TN (US); Thomas R. BLAZIER, Tullahoma, TN (US)

Correspondence Address: PITTS AND BRITTIAN P C, P O BOX 51295, KNOXVILLE, TN, 37950-1295, US

(21) Appl. No.: 12/487,234

(22) Filed: Jun. 18, 2009

(51) Int. Cl. A01M 31/02

(52) U.S. Cl. 182/187

(57) ABSTRACT

A secure, adjustable base platform for mounting upon a tree is provided. A base platform comprises a floor including a first side edge, an opposed second side edge, a front edge and a rear edge. Jaw means are secured to the floor adjacent to the rear edge. The jaw means is adapted to securely engage the bark of the tree upon which the base platform is mounted. A first extension is pivotally secured to the floor adjacent to the first side edge and a second extension is pivotally secured to the floor adjacent to the second side edge. A loop is slidably connected to the first extension and slidably connected to the second extension. The loop is sized to extend around the trunk of the tree. Means are provided for securing the loop to the first extension and the second extension. A brace extends between the first extension and the second extension. The brace is pivotally connected to the first extension and pivotally connected to the second extension. A connector is pivotally secured to the rear edge of the floor and slidably connected to the brace. Means are provided for securing the connector to the brace, whereby the relative angle between the floor and the first extension and the second extension is selectively adjustable.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

This invention pertains to tree stands.

More particularly, this invention pertains to tree stands which include an adjustable base platform.

2. Description of the Related Art

In order to have a wider range of view and to reduce the likelihood that game will detect a hunter by sense of sight or scent, tree stands are commonly used by hunters in wooded areas. A tree stand generally provides a seat and a base platform upon which the hunter may rest his/her feet or stand. The tree stand is generally secured to the trunk of a tree, elevated by a substantial distance above the ground. Accordingly, it is desirable to provide a secure means for attaching the tree stand to the tree and also to provide comfortable seating and standing conditions.

The trees upon which the stands are mounted vary in diameter. In addition, trees vary in their angle from vertical. Each of the diameter and angle of the tree can affect the pitch of the base platform and seat.

Prior tree stands have provided varying structures for controlling the pitches of the seat and base platform. Unfortunately, many of the prior mechanisms have not provided sufficiently secure adjustments, allowing the seat and/or base platform to slip. Such slippage may throw a user off balance or even allow the user to fall from the tree stand.

### BRIEF DESCRIPTION OF THE INVENTION

According to one embodiment of the present invention, a secure, adjustable base platform for mounting upon a tree is provided. A base platform comprises a floor including a first side edge, an opposed second side edge, a front edge and a rear edge. Jaw means are secured to the floor adjacent to the rear edge. The jaw means is adapted to securely engage the bark of the tree upon which the base platform is mounted.

A first extension is pivotally secured to the floor adjacent to the first side edge and a second extension is pivotally secured to the floor adjacent to the second side edge. A loop is slidably connected to the first extension and slidably connected to the second extension. The loop is sized to extend around the trunk of the tree. Means are provided for securing the loop to the first extension and the second extension.

A brace extends between the first extension and the second extension. The brace is pivotally connected to the first extension and pivotally connected to the second extension. A connector is pivotally secured to the rear edge of the floor and slidably connected to the brace. Means are provided for securing the connector to the brace, whereby the relative angle between the floor and the first extension and the second extension is selectively adjustable.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a perspective view of a tree stand base platform embodying various features of the present invention.

FIG. 2 is a perspective view of the rear edge of the base platform of FIG. 1.

FIG. 3 is perspective view of the connector and brace of the base platform of FIG. 1.

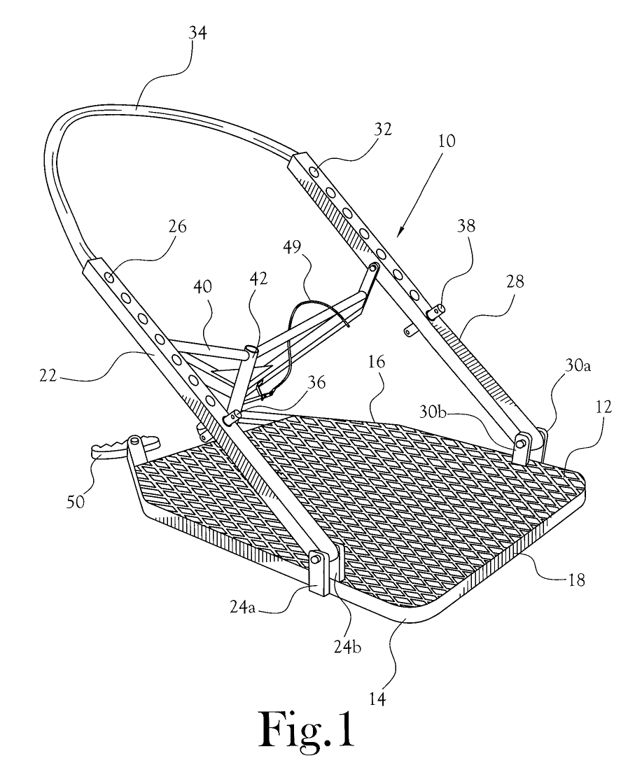

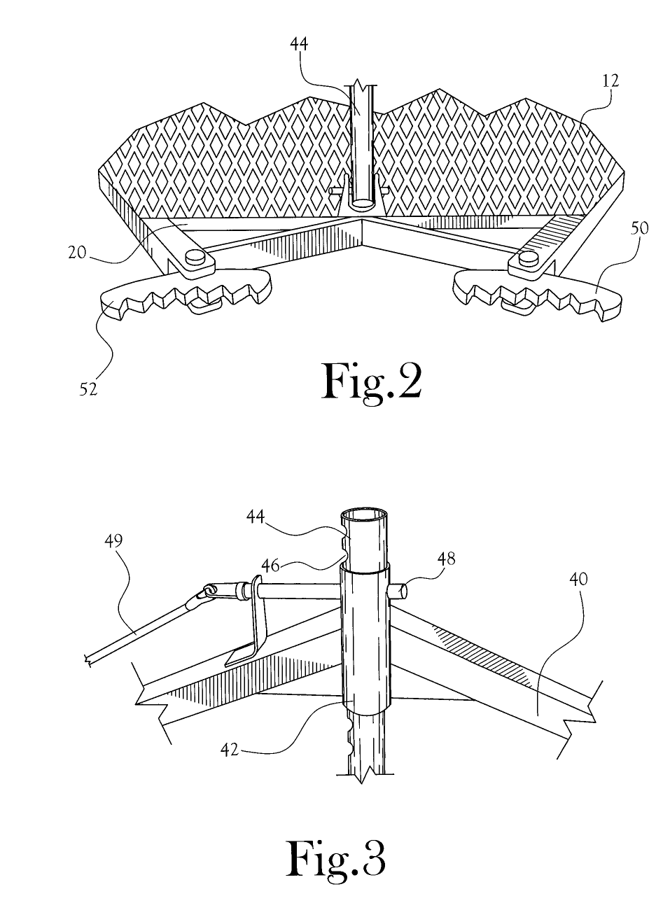

### DETAILED DESCRIPTION OF THE INVENTION

Referring to the drawings, in which like numbered parts reflect common part, a new tree stand base platform is disclosed.

The tree stand base platform 10 comprises a floor 12 having a first side edge 14, an opposed second side edge 16, a front edge 18 and an opposed rear edge 20. The floor comprises a rigid material, such as expanded steel, adapted to support the weight of a user, such as a hunter.

A first extension 22 is pivotally attached to ears 24a and 24b extending upwardly from the floor 12 adjacent to the first side edge 14. A plurality of apertures 26 are defined in the outboard section of the first extension 22. A second extension 28 is pivotally attached to ears 30a and 30b extending upwardly from the floor 12 adjacent to the second side edge 16. A plurality of apertures 32 are defined in the outboard section of the second extension 28.

A loop 34 is slidably inserted within the first extension 22 and the second extension 28. A plurality of apertures (not shown) is defined in the portions of the loop 34 which are inserted into the extensions 22 and 28. A locking pin 36 extends through an aperture 26 and the inserted portion of the loop 34 to lock the loop 34 relative to the first extension 22. A locking pin 38 extends through an aperture 32 and the inserted portion of the loop 34 to lock the loop 34 relative to the second extension 28. Removal of the locking pins 36 and 38 allows the loop 34 to be adjusted to alternate apertures 26 and 32 to adapt to differently sized trees.

A brace 40 extends between the first extension 22 and the second extension 28. The brace 40 is pivotally secured to the first extension 22 and the second extension 28. The brace includes a tube 42 adapted to slidingly engage a mating connector tube 44 which is pivotally mounted upon the floor 12 adjacent to the rear edge 20 of the floor 12. Apertures 46 defined in the tubes 42 and 44 are adapted to receive a spring-loaded pin 48. Release of the pin 48, accomplished with a cable 49 allows the tubes 42 and 44 to slide longitudinally to selectively adjust the relative angle defined by the floor 12 and the first and second extensions 22 and 28.

A first jaw 50 and a second jaw 52 are pivotally mounted upon the floor 12 adjacent to the rear edge 20.

In operation, the locking pins 36 and 38 are removed and the loop 34 is slidably withdrawn from the first extension 22 and the second extension 28. The loop 34 is encircled substantially around a tree trunk at the selected elevation. The outboard portions of the loop 34 are re-inserted into the first extension 22 and the second extension 28 until the jaws 50 and 52 are engaged against the trunk of the tree. The locking pins 36 and 38 are re-inserted into the appropriate apertures 26 and 32, respectively. The, in order to achieve the desired relative angle between the floor and the extensions 22 and 28, the pin 48 is withdrawn from the tubes 42 and 44. The relative angle is achieved and the pin 48 is re-inserted through the apertures 46 in the tubes 42 and 44.

Those skilled in the art will recognize that various telescoping relationships between the loop 34 and extensions 22 and 28 may be employed. Similarly, various locking means may be provided for securing the loop 34 to the extensions 22 and 28.

Various shapes of braces may be can be used without departing from the spirit and scope of the present invention.

From the foregoing description, it will be recognized by those skilled in the art that an improved tree stand base support has been provided.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. A base platform for mounting upon a tree comprising:
a floor including a first side edge, an opposed second side edge, a front edge and a rear edge;
a jaw secured to said floor adjacent to said rear edge, said jaw being adapted to securely engage the bark of said tree;
a first extension pivotally secured to said floor adjacent to said first side edge and a second extension pivotally secured to said floor adjacent to said second side edge;
a loop adjustably connected to said first extension and adjustably connected to said second extension, said loop being sized to extend around the trunk of said tree;
locks securing said loop to said first extension and said second extension;
a brace extending between said first extension and said second extension;
a connector pivotally secured to said rear edge of said floor and adjustably connected to said brace; and
a lock for securing said connector to said brace, whereby the relative angle between said floor and said first extension and said second extension is selectively adjustable.

2. The apparatus of claim 1 wherein said brace is pivotally mounted upon said first extension and said second extension.

3. The apparatus of claim 1 wherein said loop slidingly engages said first extension and said second extension.

4. The apparatus of claim 1 wherein said connector is slidably connected to said brace.

5. The apparatus of claim 1 wherein said brace includes a tube matingly engaging said connector.
